(19) United States
(12) Patent Application Publication
(10) Pub. No.: US 2019/0062060 A1
(43) Pub. Date: Feb. 28, 2019

(54) CONVEYING APPARATUS USING ATTRACTION MEANS

(71) Applicant: DAEBONG ENGINEERING CO., LTD., Busan (KR)

(72) Inventors: Seong Hoon KIM, Busan (KR); Jin Ki LEE, Gyeongsangnam-do (KR); Byung Ju NA, Busan (KR)

(21) Appl. No.: 15/576,617

(22) PCT Filed: Oct. 27, 2017
(86) PCT No.: PCT/KR2017/011952

§ 371 Date: Nov. 22, 2017

(30) Foreign Application Priority Data
Aug. 29, 2017 (KR) 10-2017-0109562

(51) Int. Cl. B65G 15/58; B65G 21/20; B65G 47/91

(52) U.S. Cl. CPC B65G 15/58; B65G 21/2018; B65G 2249/04; B65G 47/917; B65G 21/2036

(57) ABSTRACT

A conveying apparatus using an attraction means. The apparatus includes: a conveyor belt conveying a material; a driving unit driving the conveyor belt; a plurality of attraction means provided in the conveyor belt and configured to allow the material into close contact with an outer circumferential surface of the conveyor belt; and a control means configured to control operation of the attraction means and including a pneumatic part, a horizontally movable member moving horizontally by the pneumatic part, a vertically movable member coupled to the attraction means, and a cam part converting a horizontal movement of the horizontally movable member into a vertical movement of the vertically movable member.

### CROSS-REFERENCE TO RELATED APPLICATION

This application claims the benefit of Korea Patent Application No. 10-2017-0109562, filed on Aug. 29, 2017, in the Korean Intellectual Property Office, the disclosure of which is incorporated herein in its entirety by reference.

### BACKGROUND OF THE INVENTION

### 1. Field of the Invention

The present invention relates generally to a conveying apparatus using an attraction means. More particularly, the present invention relates to a conveying apparatus using an attraction means, the apparatus being configured such that the attraction means is operated by a control means whereby a material is attracted on a conveyor belt and conveyed.

### 2. Description of the Related Art

In general, a factory automation (FA) line system in which objects are transferred to a specific device or place using a clamping type robot arm, a belt conveyor, an attraction mechanism, etc. depending on a material or shape of the objects is utilized in an entire production process including manufacturing, processing, packing, etc.

Herein, in the case of conveying a material using a widely used conveyor belt, its main purpose is to bring the material into stable close contact on the conveyor belt and to convey the material accurately and quickly to a desired position. Conventionally, in order to achieve the above-mentioned purpose, the material is classified into a magnetic material and a non-magnetic material, wherein the magnetic material is conveyed using an attraction means provided with a permanent magnet or the like while the non-magnetic material is conveyed using an attraction means provided with a vacuum compression means. However, this independent conveying of the magnetic and non-magnetic materials is very inefficient in terms of the entire production process.

Accordingly, in an effort to solve this problem, Korean Patent No. 10-1755575 (filed on Oct. 30, 2015) disclosed an attraction means including both a magnet for attracting the magnetic material, and a profile connected with a vacuum device and attracting the non-magnetic material, and a technique of controlling an attraction force in the attraction means wherein the magnet is moved to vertically approach or retreat from the conveyor belt by operation of a vertically movable part in a state in which the attraction means is maintained to be in close contact with the inner circumferential surface of the conveyor belt whereby the attraction force due to a magnetic force is controlled, and a nozzle connecting the profile and the vacuum compression means is operated whereby the attraction force due to pneumatic pressure is controlled.

However, in the case of carrying out a mass conveying process through the conventional technique of controlling the attraction force, parts of a plurality of attraction means, which are provided to control the attraction force due to the magnetic force or the pneumatic pressure, are operated independently even when conveying only one kind of material. Accordingly, in order to operate all the parts, operation processes thereof are considerably complicated, which hinders the achievement of the purpose for a quick and simple process. In particular, when conveying both the magnetic and non-magnetic materials, the magnetic and non-magnetic material attraction means are operated independently. Thus, respective controls of the magnetic and non-magnetic materials may be performed at time intervals rather than at the same time unless an expensive high-sensitivity sensor is utilized, so a failure may occur in responsiveness. Consequently, the conventional technique is not fully compatible with the above-mentioned purpose for simultaneous conveying of the magnetic and non-magnetic materials.

### SUMMARY OF THE INVENTION

### Technical Problem

Therefore, it is a primary objective of the present invention to provide a detachable movable device and an electronic device thereof to achieve the effect of reducing the tear and wear of a touch display panel of a general electronic device.

Accordingly, the present invention has been made keeping in mind the above problems occurring in the prior art, and an object of the present invention is to provide a conveying apparatus using an attraction means, in which when a mass conveying process is performed using a plurality of attraction means, the plurality of attraction means are simultaneously operated by a minimum operation without a complicated process, and even when materials, such as magnetic and non-magnetic materials which have two or more different properties, are simultaneously attracted on the conveyor belt and conveyed, the respective materials having different properties are attracted on and released from the conveyor belt almost simultaneously at a minimum time difference.

### Technical Solution

In order to accomplish the above object, the present invention provides a conveying apparatus using an attraction means, the apparatus including: a conveyor belt conveying a material; a driving unit driving the conveyor belt; a plurality of attraction means provided in the conveyor belt and configured to allow the material into close contact with an outer circumferential surface of the conveyor belt; and a control means configured to control operation of the attraction means and including a pneumatic part, a horizontally movable member moving horizontally by the pneumatic part, a vertically movable member coupled to the attraction means, and a cam part converting a horizontal movement of the horizontally movable member into a vertical movement of the vertically movable member.

The attraction means may include: a vacuum attraction means vacuum-attracting a non-magnetic material on the outer circumferential surface of the conveyor belt, and including a profile provided on an inner circumferential surface of the conveyor belt, a connection pipe connecting the profile and an external vacuum pump to each other, and an opening and closing plate cooperating with the vertically movable member to open and close a flow path of the connection pipe; and a magnetic attraction means magnetically attracting a magnetic material on the outer circumferential surface of the conveyor belt by using a magnet provided at the vertically movable member.

The cam part may include: a pair of recessed grooves oppositely provided at upper and lower portions of the horizontally movable member, respectively; and a pair of protrusions provided at the vertically movable member and being in contact with the pair of recessed grooves, respectively.

### Advantageous Effects

According to the embodiment of the present invention, the horizontally movable member is moved horizontally by driving of the pneumatic part of the control means, and this horizontal movement causes the vertically movable member connected with the attraction means to move vertically by the cam part, whereby the attraction means is allowed to vertically approach and retreat from the inner circumferential surface of the conveyor belt by even only the driving of the pneumatic part of the control means, thereby simplifying operation during the mass conveying process.

In addition, by the configuration of the attraction means including the magnet for attraction using the magnetic force, the profile for attraction using vacuum pressure, the connection pipe connected with the profile and the external vacuum pump, and the opening and closing plate provided in the connection pipe and coupled with the vertically movable member, the opening and closing plate opening and closing the connection pipe and the external vacuum pump, the magnet is moved vertically from the inner circumferential surface of the conveyor belt in response to the vertical movement of the attraction means by the above-described driving of the pneumatic part, and the opening and closing plate is also moved vertically to open and close the connection pipe and the external vacuum pump. As a result, even when the magnetic and non-magnetic materials are simultaneously attracted on the conveyor belt and conveyed, it is possible to control the attraction force relative to the magnetic and non-magnetic materials by driving only the pneumatic part, and to simultaneously drive the magnet and the opening and closing plate, thereby exhibiting considerable responsiveness during the mass conveying process.

Moreover, by the configuration of the cam part including the pair of recessed grooves formed at the upper and lower portions of the horizontally movable member, and the pair of protrusions formed at the vertically movable member to correspond to the pair of recessed grooves, when the horizontally movable member operates, one of the pair of protrusions naturally slides and is tightly engaged with one of the pair of recessed grooves. As a result, it is possible to significantly reduce loss attributable to friction and resistance of the cam part.

### BRIEF DESCRIPTION OF THE DRAWINGS

FIG. 1 is a side cross-sectional view showing a conveying apparatus using an attraction means according to a preferred embodiment of the present invention.

FIG. 2 is an enlarged cross-sectional view showing an attraction means and a control means of the conveying apparatus using the attraction means, which corresponds to a portion A of FIG. 1.

FIG. 3a is a cross-sectional view showing material attraction operation of the conveying apparatus using the attraction means shown in FIG. 2.

FIG. 3b is a cross-sectional view showing of material releasing operation of the conveying apparatus using the attraction means shown in FIG. 2.

FIG. 4 is a cross-sectional view showing an embodiment of a plurality of apparatuses according the present invention.

### DETAILED DESCRIPTION OF THE PREFERRED EMBODIMENTS

Reference will now be made in detail to exemplary embodiments and the accompanying drawings of the present invention, in which the same reference numerals are used throughout the different drawings to designate the same or similar components.

Hereinafter, a conveying apparatus using an attraction means according to an embodiment of the present invention will be described with reference to the accompanying drawings.

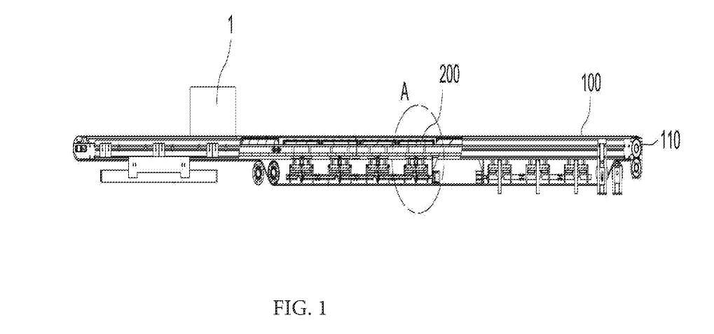

With reference to FIG. 1, which is a side cross-sectional view showing the conveying apparatus using the attraction means according to the embodiment of the present invention, the conveying apparatus using the attraction means according to the embodiment of the present invention mainly includes a conveyor belt 100 conveying a material 1, a driving unit 110 driving the conveyor belt, a plurality of attraction means 200 provided on an inner circumferential surface of the conveyor belt and configured to attract the material 1 on an outer circumferential surface of the conveyor belt 100, and a control means controlling the attraction means 200.

First, the conveyor belt 100 has a predetermined width to carry and convey the material 1 and is circularly rotated by the driving unit 110. The material 1 conveyed by the conveyor belt 100 may include all magnetic and non-magnetic materials 1 utilized in the industry.

Herein, the material 1 is conveyed upward on the conveyor belt as shown in FIG. 1. In addition, the material may be conveyed toward the ground when the conveyor belt 100 is located on the upper surface of the material.

Next, the driving unit 110 is provided at opposite ends of the conveyor belt 100 and may include all kinds of well known power generating and power transmitting means such as a motor, a pulley and the like for rotating the conveyor belt 100.

Further, the attraction means 200 is means for attracting and releasing the material 1 on the outer circumferential surface of the conveyor belt 100, and is provided on the inner circumferential surface of the conveyor belt 100.

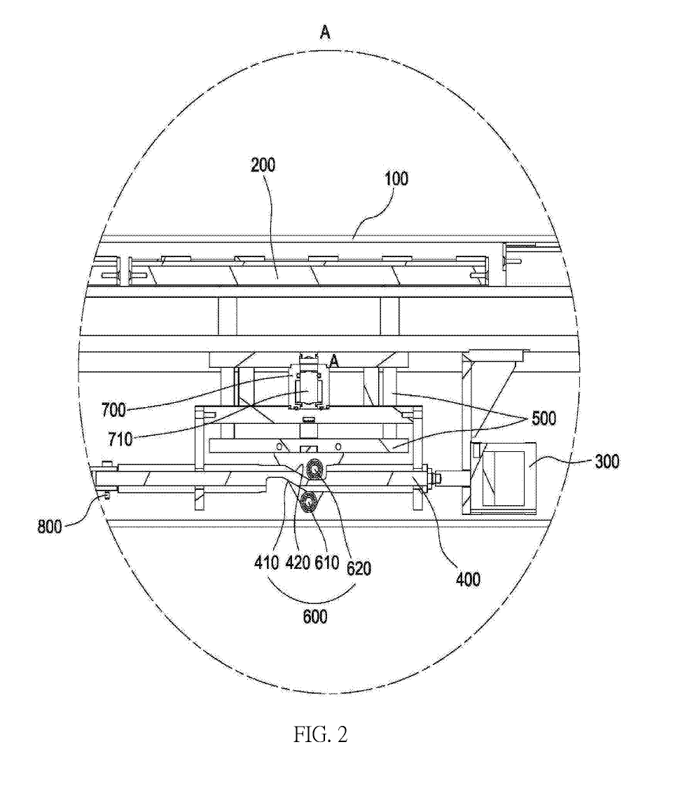

FIG. 2 is an enlarged cross-sectional view showing the attraction means and the control means of the conveying apparatus using the attraction means, which corresponds to a portion A of FIG. 1, and the attraction means 200 will be described in detail.

First, referring to FIG. 2, the attraction means 200 according to the preferred embodiment of the present invention may include at least one of: a magnetic attraction means composed of a magnet; and a vacuum attraction means composed of the profile, a connection pipe 700 connecting the profile and an external vacuum pump to each other, and an opening and closing plate 710 configured to open and close a flow path of the connection pipe 700 by cooperating with a vertically movable member. The magnetic attraction means serves to attract a magnetic object, and the vacuum attraction means serves to attract a non-magnetic object.

Next, the way of attracting the material 1 by the magnetic attraction means and vacuum attraction means is described as follows. The magnet that is the magnetic attraction means, and the profile that is the vacuum attraction means control an attraction force due to a magnetic force and pneumatic pressure through vertical distance adjustment from the conveyor belt 100, and the vacuum attraction means will be described in detail below.

First, the profile having a plurality of grooves is connected with the connection pipe 700 by using a nozzle or the like such that the grooves communicate with the connection pipe 700. Then, the external vacuum pump connected with the connection pipe 700 sucks air in the grooves to control an internal pressure of the grooves to be lower than an external pressure, which creates a pressure difference between inner and outer spaces of the grooves, whereby the attraction force due to the pressure difference acts to attract the material 1 located outside the grooves on the outer circumferential surface of the conveyor belt 100.

Next, the control means configured to move the attraction means 200 upward and downward will be described with reference to FIG. 2.

As shown in FIG. 2, the control means is provided on the inner circumferential surface of the conveyor belt 100, and includes a pneumatic part 300, a horizontally movable member 400, a vertically movable member 500, and a cam part 600.

First, the pneumatic part 300, which drives the control means, is provided on a side of the horizontally movable member 400, and serves to move the horizontally movable member 400 forward and backward by a pneumatic cylinder actuation.

This forward and backward movement causes the vertically movable member 500 to move vertically by operation of the cam part 600 cooperating with the vertically movable member 500, whereby the attraction means 200 connected with the vertically movable member 500 is also moved vertically from the inner circumferential surface of the conveyor belt 100.

In this case, the cam part 600 according to the preferred embodiment of the present invention includes a pair of recessed grooves 410 and 420 oppositely provided at upper and lower portions of the horizontally movable member 400, and a pair of protrusions 610 and 620 provided at the vertically movable member 500 and being in contact with the recessed grooves 410 and 420, respectively.

Accordingly, since the contact surfaces between the respective members of the cam part 600 of the control means are smoothly formed, it is possible to prevent damage due to friction during operation of the cam part 600 and to cause natural operation of the vertically movable member 500.

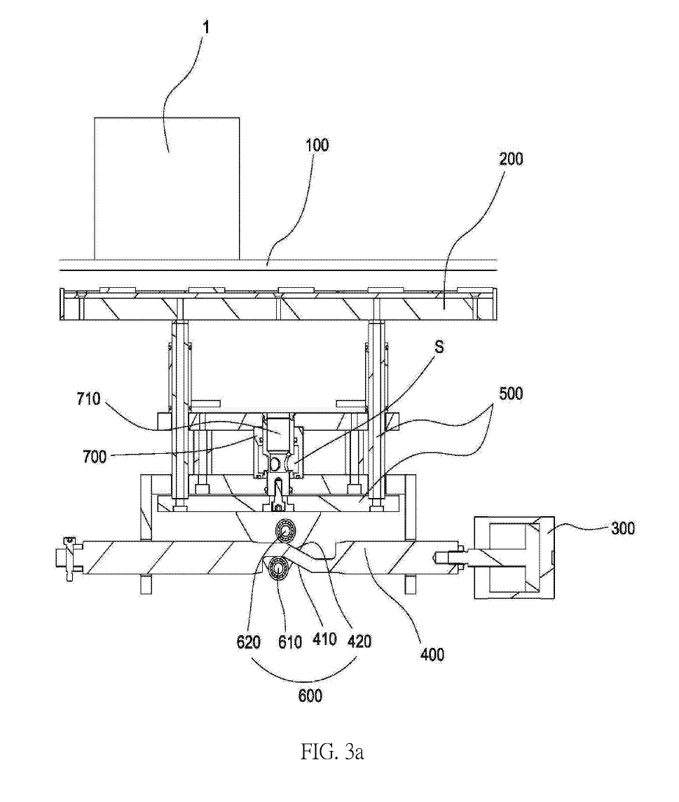

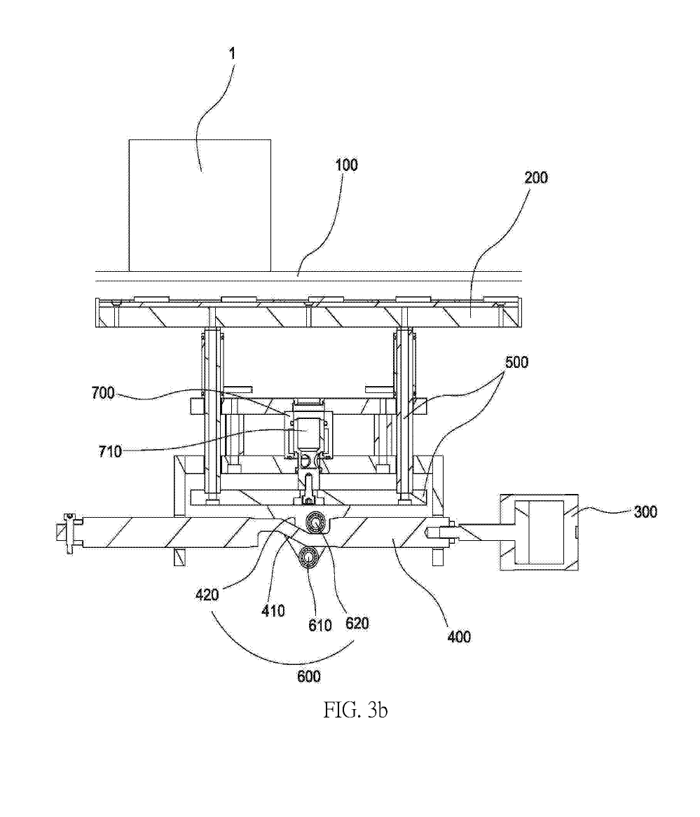

Next, a process of controlling the attraction means 200 provided with the magnetic attraction means and the vacuum attraction means by the control means is described with reference to FIG. 3a showing material attraction operation of the conveying apparatus using the attraction means shown in FIG. 2, and FIG. 3b showing material releasing operation of the conveying apparatus using the attraction means shown in FIG. 2.

First, as shown in FIG. 3a, when the horizontally movable member 400 moves backward to the right, the pair of protrusions 610 and 620 slide to the left of the pair of recessed grooves 410 and 420, whereby the vertically movable member 500 connected with the pair of protrusions 610 and 620 and the attraction means 200 connected with the vertically movable member 500 are moved upward, and the opening and closing plate 710 connected with the vertically movable member 500 is also moved upward by an amount corresponding to an opening/closing space S.

Accordingly, the attraction means 200 including the magnet and the profile comes into close contact with the inner circumferential surface of the conveyor belt 100, and through cooperation between the vertically movable member 500 and the opening and closing plate 710, an air suction passage of the external vacuum pump, which is defined inside the connection pipe 700, is secured by the amount corresponding to the opening/closing space S.

On the contrary, as shown in FIG. 3b, when the horizontally movable member 400 moves forward to the left, the pair of protrusions 610 and 620 slide to the right of the pair of recessed grooves 410 and 420, whereby the vertically movable member 500 and the attraction means 200 are moved downward and the magnet is moved away from the conveyor belt 100, and the opening and closing plate 710 is moved downward by the amount corresponding to the opening/closing space S of FIG. 3a to close a gap defined between the external vacuum pump and the connection pipe 700.

Accordingly, the attraction means 200 including the magnet and the profile is moved away from the inner circumferential surface of the conveyor belt 100, and the opening/closing space S defined between the connection pipe 700 and the external vacuum pump is also closed by the opening and closing plate 710.

Thus, the control means vertically moves the attraction means 200 connected with the vertically movable member 500 by driving only the pneumatic part 300, and at the same time controls the magnetic attraction means and the vacuum attraction means. Consequently, it is possible to unify the entire conveying process of using the attraction means to thereby increase convenience of the process, and to minimize a time difference that may occur during simultaneous attraction/release of the magnetic and non-magnetic materials 1.

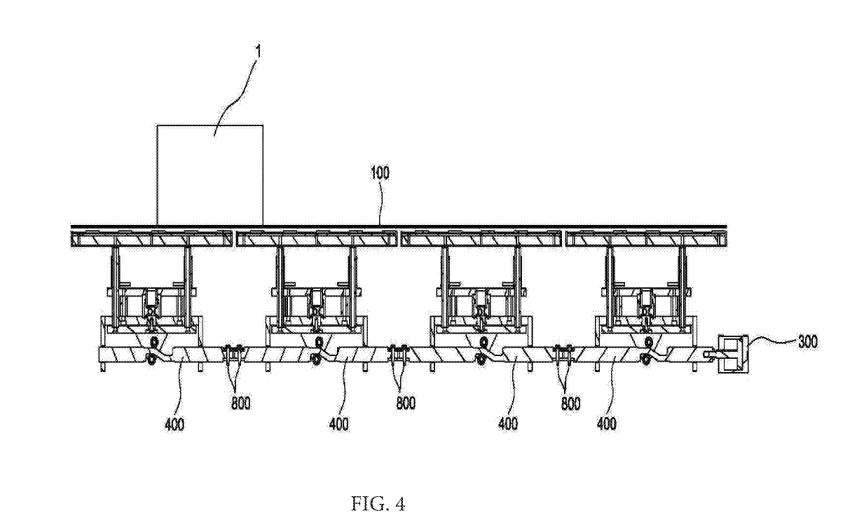

In addition, as shown in FIG. 4, which is a cross-section view showing an embodiment of a plurality of apparatuses according to the present invention, when a plurality of horizontally movable members 400 are horizontally connected to each other through a fastener 800, one pneumatic part 300 is provided at a side of the plurality of horizontally movable members 400, whereby the plurality of the horizontally movable members 400 is horizontally cylindrically driven by one pneumatic part 300. Consequently, it is possible to control the entire conveying process of using the attraction means by driving only the pneumatic part 300 even during a mass conveying process, which can be interacted with the embodiment of simultaneous conveying of the magnetic and non-magnetic materials 1 described above.

Although a preferred embodiment of the present invention has been described for illustrative purposes, those skilled in the art will appreciate that various modifications, additions and substitutions are possible, without departing from the scope and spirit of the invention as disclosed in the accompanying claims.

### DESCRIPTION OF THE REFERENCE NUMERALS IN THE DRAWINGS

1: material
100: conveyor belt
110: driving unit
200: attraction means
300: pneumatic part
400: horizontally movable member
410, 420: a pair of recessed grooves
500: vertically movable member
600: cam part
610, 620: a pair of protrusions
700: connection pipe
710: opening and closing plate
800: fastener
S: opening/closing space

What is claimed is:

1. A conveying apparatus using an attraction means, the apparatus comprising:
a conveyor belt conveying a material;
a driving unit driving the conveyor belt;
a plurality of attraction means provided in the conveyor belt and configured to allow the material to come into close contact with an outer circumferential surface of the conveyor belt; and
a control means configured to control operation of the attraction means and including a pneumatic part, a horizontally movable member moving horizontally by the pneumatic part, a vertically movable member coupled to the attraction means, and a cam part converting a horizontal movement of the horizontally movable member into a vertical movement of the vertically movable member.

2. The apparatus of claim 1, wherein the attraction means includes:
a vacuum attraction means vacuum-attracting a non-magnetic material on the outer circumferential surface of the conveyor belt, and including a profile provided on an inner circumferential surface of the conveyor belt, a connection pipe connecting the profile and an external vacuum pump to each other, and an opening and closing plate cooperating with the vertically movable member to open and close a flow path of the connection pipe; and
a magnetic attraction means magnetically attracting a magnetic material on the outer circumferential surface of the conveyor belt by using a magnet provided at the vertically movable member.

3. The apparatus of claim 1, wherein the cam part includes:
a pair of recessed grooves oppositely provided at upper and lower portions of the horizontally movable member, respectively; and
a pair of protrusions provided at the vertically movable member and being in contact with the pair of recessed grooves, respectively.
